(19) United States
(12) Patent Application Publication
(10) Pub. No.: US 2016/0110909 A1
(43) Pub. Date: Apr. 21, 2016

(54) METHOD AND APPARATUS FOR CREATING TEXTURE MAP AND METHOD OF CREATING DATABASE

(71) Applicant: SAMSUNG SDS CO., LTD., Seoul (KR)

(72) Inventors: Bo Youn KIM, Seoul (KR); Sang Hak LEE, Seoul (KR); Jong Hang KIM, Seoul (KR); Seong Jong HA, Seoul (KR); Young Min SHIN, Seoul (KR); Yu Ri AHN, Seoul (KR); Yeon Hee KWON, Seoul (KR); Sun Ah KANG, Seoul (KR)

(73) Assignee: SAMSUNG SDS CO., LTD., Seoul (KR)

(21) Appl. No.: 14/887,425

(22) Filed: Oct. 20, 2015

(30) Foreign Application Priority Data
Oct. 20, 2014 (KR) 10-2014-0141857

(51) Int. Cl. G06T 15/04; G06F 17/30; G06T 17/20; G06K 9/46; G06T 15/50; G06K 9/00

(52) U.S. Cl. CPC G06T 15/04; G06T 15/503; G06K 9/00268; G06T 17/20; G06K 9/46; G06K 9/00255; G06K 9/00288; G06F 17/30256; G06F 17/30262; G06F 17/30259; G06F 17/30271

(57) ABSTRACT

A method of creating a texture map is provided. The method includes extracting feature points of a particular object from one or more image frames captured by a camera; selecting one of the image frames as an image frame to be used in the creation of a texture map of the particular object based on information regarding the extracted feature points; and creating the texture map of the particular object using the selected image frame.

This application claims priority to Korean Patent Application No. 10-2014-0141857 filed on Oct. 20, 2014 in the Korean Intellectual Property Office, the disclosure of which is incorporated herein by reference in its entirety.

### BACKGROUND

1. Field of the Invention

The invention relates to a method and apparatus for creating a texture map and a method of creating a database, and more particularly, to a method and apparatus for creating a texture map, which can create a texture map for representing a three-dimensional (3D) object based on a two-dimensional (2D) image, and a method of creating a database for face recognition using the created texture map.

2. Description of the Related Art

Face recognition is a technique of detecting part of a moving or still image that appears to be the face of a person and acquiring various information such as identifying who the person is.

Face recognition is largely classified into a two-dimensional (2D) face recognition method and a three-dimensional (3D) face recognition method.

Examples of the 2D face recognition method include a method using an image of an entire face area as an input for face recognition and a method extracting local features such as the eyes, the nose and the mouth from an image of a face and using a statistical model to recognize the face. The former method, in particular, is not robust against variations in lighting, poses, or facial expressions.

In a typical camera monitoring system environment, cameras are generally installed at a height of 3 m or more. Thus, the resolution of images captured by the cameras may not be sufficiently high, and it may be difficult to obtain a frontal face image depending on the pose. Accordingly, when face recognition is performed using local features, it may be difficult and time-consuming to precisely detect the characteristics of a face.

The 3D face recognition method creates a 3D face model based on a 2D image. Then, by using the 3D face model, a database that can encompass various poses, various facial expressions, and various lighting conditions is created. Then, by using the database, a face may be recognized from an image captured by a camera.

In order to create a 3D face model based on a 2D image, a frontal face image is needed.

### SUMMARY

Exemplary embodiments of the invention provide a method and apparatus for creating a texture map, which are capable of creating a texture map for use in the creation of a 3D model of a particular object based on a two-dimensional (2D) image without a requirement of a frontal image of the particular object. The 3D model of the particular object may be a model obtained by texturing a texture map corresponding to the particular object to a 3D standard model.

Exemplary embodiments of the invention also provide a method and apparatus for creating a texture map, which are capable of creating a precise texture map.

Exemplary embodiments of the invention also provide a method of creating a database, which is capable of creating a 3D model of a particular face using a texture map and creating and organizing various information regarding the particular face in the form of a database using the created 3D model.

However, exemplary embodiments of the invention are not restricted to those set forth herein. The above and other exemplary embodiments of the invention will become more apparent to one of ordinary skill in the art to which the invention pertains by referencing the detailed description of the invention given below.

According to an exemplary embodiment of the invention, a method of creating a texture map, includes: extracting feature points of a particular object from one or more image frames captured by a camera; selecting one of the image frames as an image frame to be used in the creation of a texture map of the particular object based on information regarding the extracted feature points; and creating the texture map of the particular object using the selected image frame.

According to another exemplary embodiment of the invention, a method of creating a database for face recognition, includes: calculating vertex coordinates of a mesh corresponding to each pixel of a standard UV texture map using a 3D standard face model and the standard UV texture map; extracting feature points of a particular face from one or more image frames; selecting one of the image frames as an image frame to be used in the creation of a texture map of the particular face based on the number of extracted feature points; creating the texture map of the particular face using the selected image frame; creating a 3D model of the particular face by performing texturing using the texture map of the particular face, the vertex coordinates, and the 3D model of the particular face; and creating a database regarding the particular face using the 3D model of the particular face and a rendering technique.

According to another exemplary embodiment of the invention, an apparatus for creating a texture map, includes: a feature point extraction unit extracting feature points of a particular object from one or more image frames captured by a camera; a frame selection unit selecting one of the image frames as an image frame to be used in the creation of a texture map of the particular object based on information regarding the extracted feature points; and a texture map creation unit creating the texture map of the particular object using the selected image frame.

According to another exemplary embodiment of the invention, a computer program stored in a medium and combined with a hardware element, performs a method of creating a texture map, and the method of creating a texture map, includes: extracting feature points of a particular object from one or more image frames captured by a camera; selecting one of the image frames as an image frame to be used in the creation of a texture map of the particular object based on information regarding the extracted feature points; and creating the texture map of the particular object using the selected image frame.

According to the exemplary embodiments, it is possible to create a precise texture map.

In addition, it is possible to create a texture map without a requirement of a frontal image of a particular object.

Moreover, it is possible to recognize a face with high precision by creating a 3D model of a particular face using a texture map and creating and organizing various information regarding the particular face in the form of a database using the created 3D model.

Other features and exemplary embodiments will be apparent from the following detailed description, the drawings, and the claims.

### BRIEF DESCRIPTION OF THE DRAWINGS

FIG. 1 is a flowchart illustrating a method of creating a texture map, according to an exemplary embodiment of the invention.

FIG. 2 is a schematic view of an example of a three-dimensional (3D) standard face model.

FIG. 3 is a schematic view of an example of a standard UV texture map.

FIG. 4 is a flowchart illustrating a modified example of the method of FIG. 1, which further includes operation S600.

FIG. 5 is a detailed flowchart of operation S400 of FIG. 1.

FIG. 6 is a detailed flowchart of operation S500 of FIG. 1.

FIG. 7 is a flowchart illustrating a method of creating a database for face recognition, according to an exemplary embodiment of the invention, which uses the method of FIGS. 1 to 6.

FIG. 8 is a block diagram of an apparatus for creating a texture map, according to an exemplary embodiment of the invention.

FIG. 9 is a configuration view of the apparatus of FIG. 8.

### DETAILED DESCRIPTION OF THE EMBODIMENTS

Advantages and features of the invention and methods of accomplishing the same may be understood more readily by reference to the following detailed description of exemplary embodiments and the accompanying drawings. The invention may, however, be embodied in many different provides and should not be construed as being limited to the embodiments set forth herein. Rather, these embodiments are provided so that this disclosure will be thorough and complete and will fully convey the concept of the invention to those skilled in the art, and the invention will only be defined by the appended claims Like reference numerals refer to like elements throughout the specification.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. As used herein, the singular forms “a,” “an,” and “the” are intended to include the plural forms, including “at least one,” unless the content clearly indicates otherwise.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

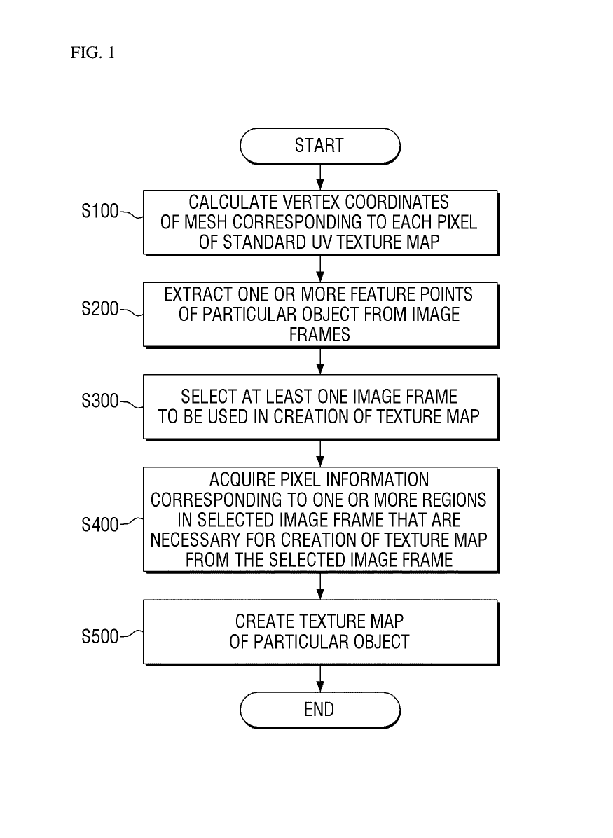

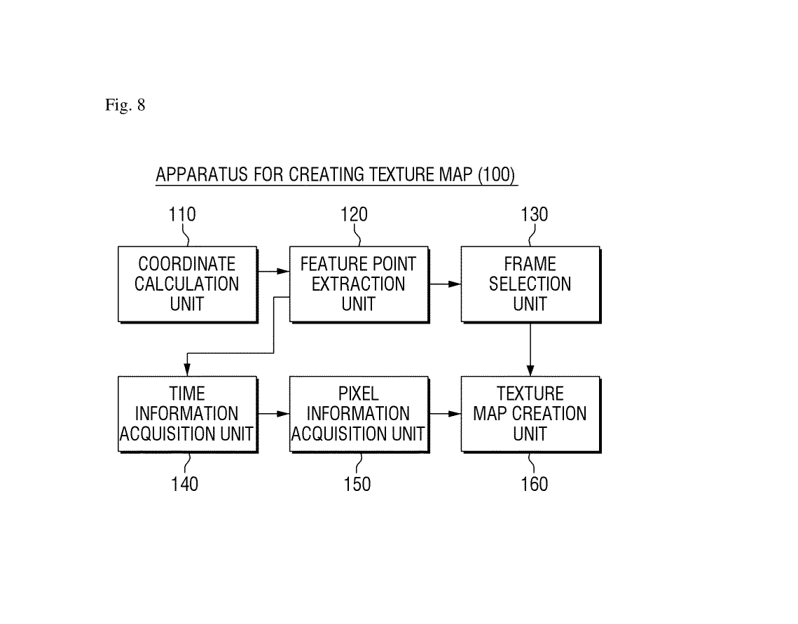

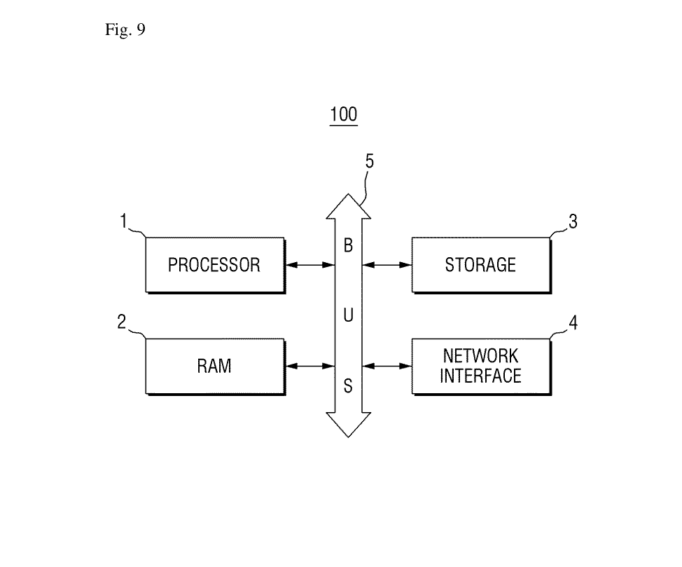

Methods of creating a texture map, according to exemplary embodiments of the invention, will hereinafter be described with reference to FIGS. 1 to 6. The exemplary embodiments of the invention may be performed by a computing device equipped with calculating means. The computing device may be, for example, an apparatus for creating a texture map, according to an exemplary embodiment of the invention. The structure of apparatus for creating a texture map will be described later in detail with reference to FIGS. 8 and 9.

FIG. 1 is a flowchart illustrating a method of creating a texture map, according to an exemplary embodiment of the invention.

Referring to FIG. 1, the apparatus for creating a texture map calculates vertex coordinates using a standard object model and a standard UV texture map (S100).

More specifically, the coordinates of each vertex of a mesh corresponding to each pixel of the standard UV texture map may be calculated using a three-dimensional (3D) standard object model and the standard UV texture map.

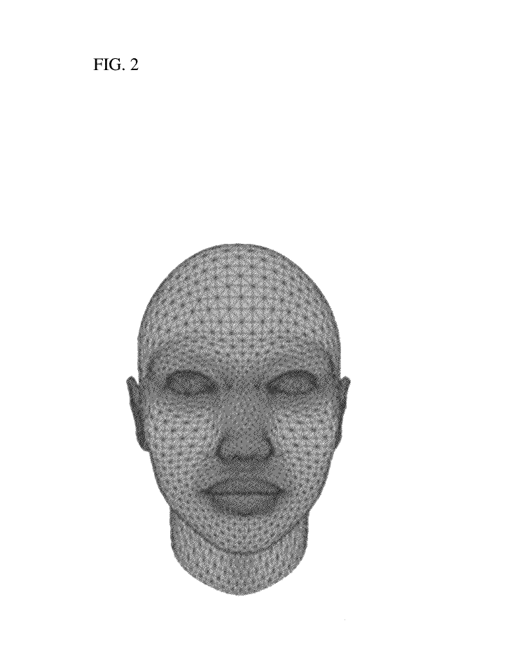

FIG. 2 is a schematic view of an example of a 3D standard face model.

Referring to FIG. 2, if a particular object of interest is a human face, a 3D standard face model for the particular object may be as illustrated in FIG. 2.

The 3D standard face model may be created in consideration of the nationality, age and sex of an individual of interest.

Each triangle on the surface of the 3D standard face model may be considered a mesh.

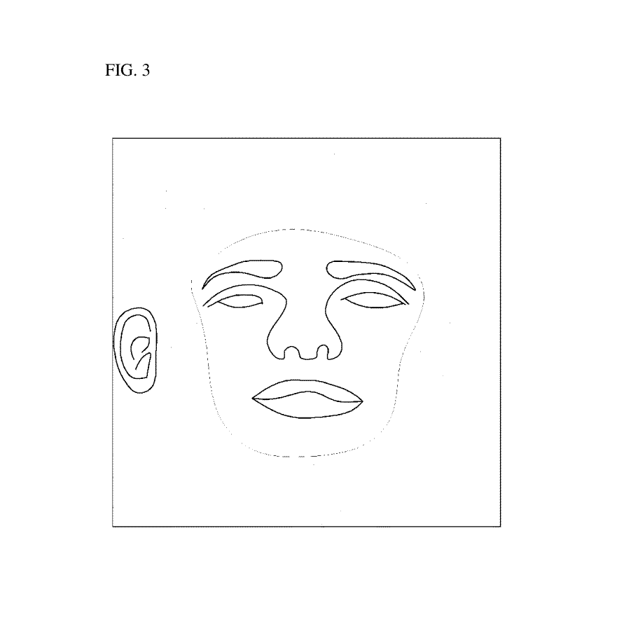

FIG. 3 is a schematic view of an example of a standard UV texture map.

Referring to FIGS. 2 and 3, the apparatus for creating a texture map may use a standard face model and a standard UV texture map to calculate vertex coordinates that show what pixel of the standard UV texture map corresponds to what mesh of the standard face model.

The vertex coordinates may be calculated using a well-known technique.

Referring back to FIG. 1, the apparatus for creating a texture map extracts feature points of the particular object from one or more image frames (S200).

The image frames may be frames of an image captured by a camera. The image frames may constitute an image captured by a single camera or images captured by multiple cameras.

That is, in the method of FIG. 1, when there are multiple images of the particular object captured by multiple cameras, frames from the multiple images may be used.

If there are provided first, second, and third image frames where the particular object appears, the apparatus for creating a texture map may extract feature points of the particular object from each of the first, second, and third image frames.

The first image frame may not necessarily be an image frame captured first by a camera. Rather, each of the first, second, and third image frames may be any image frame captured by a camera.

The number of, and information regarding, feature points may differ from the first image frame to the second image frame to the third image frame depending on the movement of the particular object or the viewpoint of a camera. More specifically, the expression “feature point information differing from one image frame to another image frame”, as used herein, means that feature points extracted from different image frames may differ from one another. For example, if the particular object is a human face, the centers of the pupils, the sides of the nose and the corners of the mouth may be extracted as feature points. If one of the pupil centers, one of the nose sides and one of the mouth corners are extracted from the first image frame and both the pupil centers and both the nose sides, but none of the mouth corners, are extracted from the second image frame, it may be determined that feature point information differs from the first image frame to the second image frame. More specifically, it may be determined that information regarding the pupil center and the nose side that are only extracted from the second image frame and information regarding the mouth corner that is only extracted from the first image frame differ from the first image frame to the second image frame.

The apparatus for creating a texture map may extract a predefined group of feature points.

For example, if the particular object is a human face, the apparatus for creating a texture map may extract, for example, the centers of the pupils, the ends of the eyes, the sides of the nose, and the corners of the mouth as the predefined group of feature points. The predefined group of feature points may be set or modified according to the computing power of a computing device that performs the method of FIG. 1 or according to a user setting.

The apparatus for creating a texture map may select at least one of the image frames as an image frame to be used in the creation of a texture map (S300).

More specifically, the apparatus for creating a texture map may select at least one of the image frames based on information regarding the feature points extracted from each of the image frames. For example, the apparatus for creating a texture map may select at least one of the image frames based on the number of feature points extracted from each of the image frames.

For example, if the first image frame, which is one of the image frames, includes an entire first group of feature points that is set in advance, the apparatus for creating a texture map may select the first image frame as the image frame to be used in the creation of a texture map.

Feature points that can be used to determine whether an image of the particular object is a frontal image may be selected as the first group of feature points.

If the particular object is a human face, a frontal image of the particular object may be a frontal face image. Once a frontal image of the particular object has been captured, it may be determined that sufficient information has been obtained to create a texture map of the particular object.

As mentioned above, the first group of feature points may include the centers of the pupils, the ends of the eyes, the sides of the nose, and the corners of the mouth.

Alternatively, the first group of feature points may be set only to the extent that they can be indicative of whether sufficient information to create a texture map of the particular object has been obtained. For example, the first group of feature points may include both the centers of the pupils and both the sides of the nose, but only one of the corners of the mouth. That is, the first group of feature points may include the same feature points as the predefined group of feature points or may include only some of the feature points included in the predefined group of feature points.

In response to it being determined that the first image frame is sufficient to create a texture map, the apparatus for creating a texture map may select only the first image frame as an image to be used for the creation of a texture map. On the other hand, in response to it being determined that the first image frame is not sufficient to create a texture map, the apparatus for creating a texture map may further select another image frame for the creation of a texture map.

That is, the apparatus for creating a texture map may select a plurality of image frames suitable for the creation of a texture map.

For example, the apparatus for creating a texture map may select at least one image frame from which more than a predefined number of feature points are extracted as the image frame to be used in the creation of the texture map of the particular object.

If the feature points extracted from the selected image frame encompass the entire first group of feature points, the apparatus for creating a texture map may select no further image frame because a texture map can be created based on the already-selected image frame. Alternatively, the apparatus for creating a texture map may further select one or more additional image frames to create a texture map with a higher precision.

In response to there being only one image frame from which more than the predefined number of feature points are extracted, the apparatus for creating a texture map may select the corresponding image frame as the image frame to be used in the creation of the texture map of the particular object.

The apparatus for creating a texture map may create the texture map of the particular object using the selected image frame (S500).

Before the creation of the texture map of the particular object, the apparatus for creating a texture map may acquire pixel information corresponding to one or more regions in the selected image frame that are necessary for the creation of the texture map of the particular object from the selected image frame (S400).

The expression “a selected image frame”, as used herein, does not exclude the case when more than one image frame is selected.

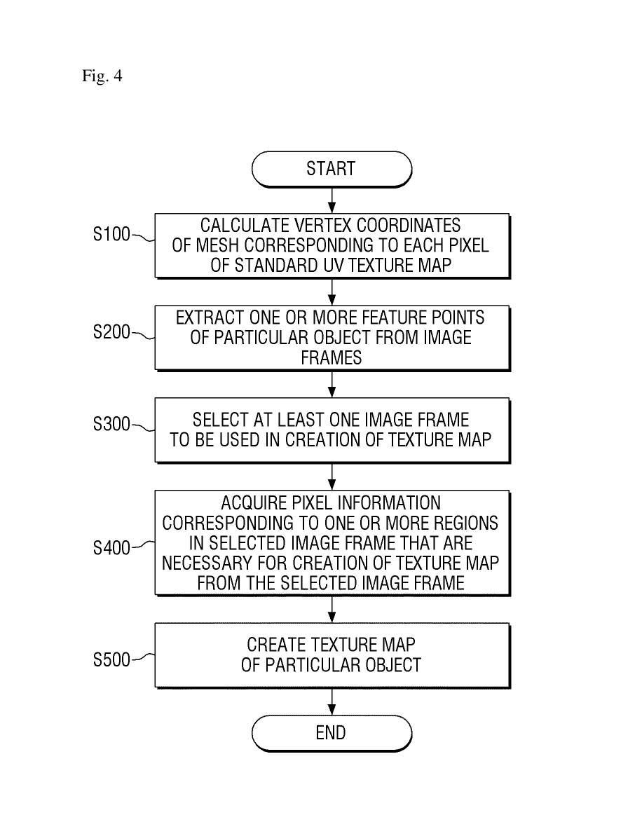

FIG. 4 is a flowchart illustrating a modified example of the method of FIG. 1, which further includes operation S600.

Referring to FIG. 4, the apparatus for creating a texture map may perform high-resolution processing to improve the resolution of at least one selected image frame (S600) before the operation of acquiring pixel information corresponding to one or more regions in the selected image frame that are necessary for the creation of a texture map from the selected image frame, i.e., operation S400

Step S600 may be performed to improve the resolution of the selected image frame, and may be performed before the operation of extracting feature points, i.e., operation S200.

That is, operation S600 may be performed on all image frames so as to help extract feature points with high precision.

It may be determined whether to perform operation S600 on all image frames or only on the selected image frame based on the resolution of the original image frames captured by a camera and the computing power of a computing device that performs the method of 4, and the order in which to perform operation S600 may vary accordingly.

High-resolution processing may be performed using various techniques that are well known in the art to which the invention pertains.

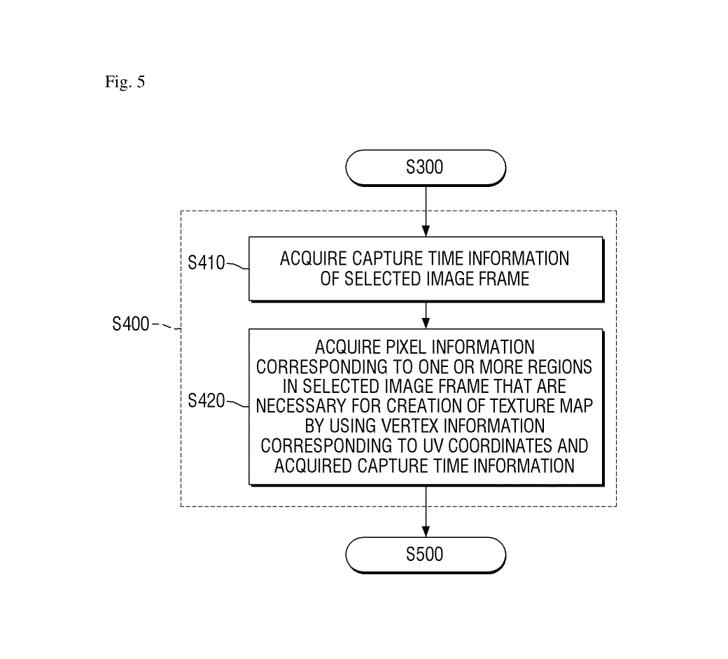

FIG. 5 is a detailed flowchart of operation S400 of FIG. 1.

Referring to FIG. 5, the apparatus for creating a texture map acquires capture time information of the selected image frame (S410).

More specifically, the apparatus for creating a texture map acquires the capture time information of the selected image frame using the feature points extracted from the selected image frame, feature points of the 3D standard object model, and parameter information of the camera used to capture the selected image frame.

The apparatus for creating a texture map may acquire pixel information corresponding to one or more regions in the selected image frame that are necessary for the creation of a texture map by using vertex information corresponding to UV coordinates and the capture time information of the selected image frame (S420).

That is, the apparatus for creating a texture map may acquire pixel information, which can correspond to a standard UV texture map, from the selected image frame.

The apparatus for creating a texture map may create a texture map of a particular object using pixel information corresponding to one or more regions in the selected image frame that are necessary for the creation of the texture map, instead of using entire pixel information of the selected image frame.

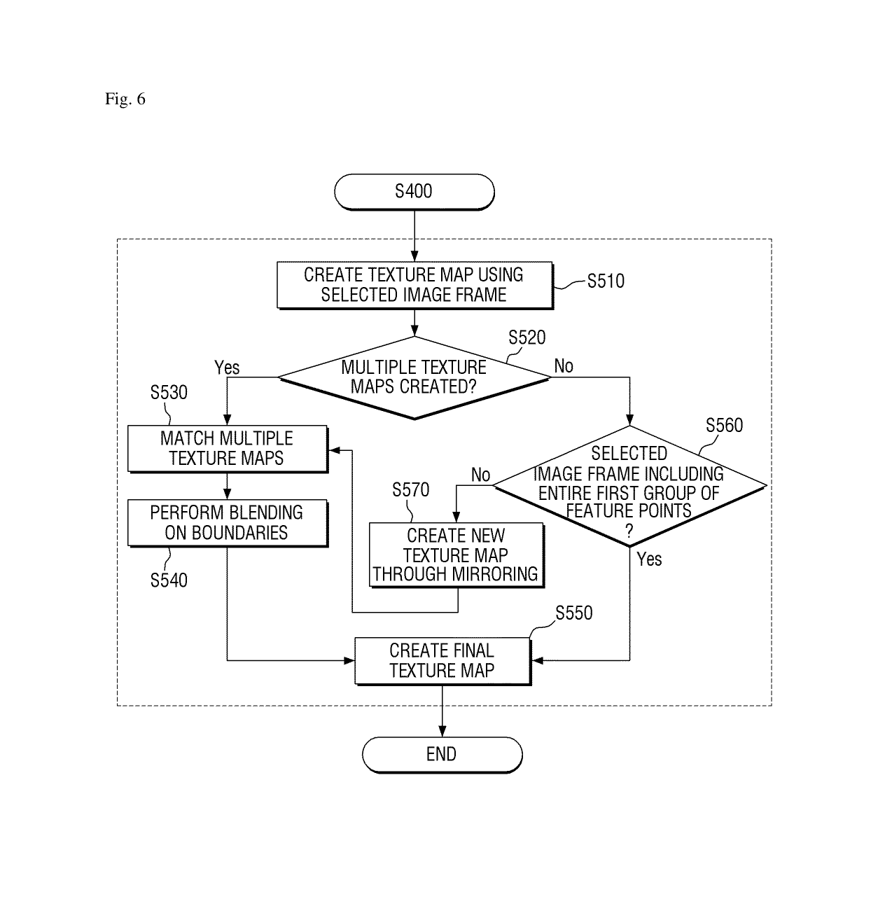

The creation of a texture map as performed in the method of FIG. 1 will hereinafter be described with reference to FIG. 6.

FIG. 6 is a detailed flowchart of operation S500 of FIG. 1.

Referring to FIG. 6, the apparatus for creating a texture map creates a texture map using the selected image frame (S510).

The apparatus for creating a texture map may generate the texture map using pixel information corresponding only to one or more regions in the selected image frame that are necessary.

The apparatus for creating a texture map may create a texture map from one selected image frame. The apparatus for creating a texture map may create n texture maps from n selected image frames. That is, the apparatus for creating a texture map may create as many texture maps as there are selected image frames.

In response to a plurality of texture maps being generated (S520), the apparatus for creating a texture map may match the plurality of texture maps together (S530).

More specifically, in response to there existing a plurality of selected image frames, a plurality of texture maps may be generated in operation S510, and the apparatus for creating a texture map may match the plurality of texture maps together, thereby creating a single texture map.

For example, the apparatus for creating a texture map may match the plurality of texture maps together using various methods such as minimizing the luminance of the overlapping area of the plurality of texture maps.

The apparatus for creating a texture map may blend boundaries that are formed in the process of matching the plurality of texture maps together (S540).

The apparatus for creating a texture map may provide a texture map obtained by matching and blending processes performed in operations S530 and S540 as a final texture map of a particular object.

The blending process may be a process for smoothly connecting the plurality of texture maps to one another along the boundaries that are formed in the process of matching the plurality of texture maps together.

In response to only one texture map being created and the image frame used to create the texture map including the entire first group of feature points (S520 and S560), the apparatus for creating a texture map may determine the texture map as the final texture map of the particular object (S550).

On the other hand, in response to only one texture map being created and the image frame used to create the texture map including only some of the first group of feature points (S520 and S560), the apparatus for creating a texture map may mirror the created texture map to create a new texture map (S570).

The apparatus for creating a texture map may match the texture map obtained in operation S510 and the texture map obtained in operation S570 (S530). The apparatus for creating a texture map may perform blending on a texture map obtained by the matching performed in S530, thereby obtaining the final texture map of the particular object (S550).

The method of FIGS. 1 to 6, including operation S570, may be effective especially when only profile images of the particular object (for example, a human face) are available.

The method of FIGS. 1 to 6, including operation S530, can create the texture map of the particular object even when a non-frontal image is captured from the particular object.

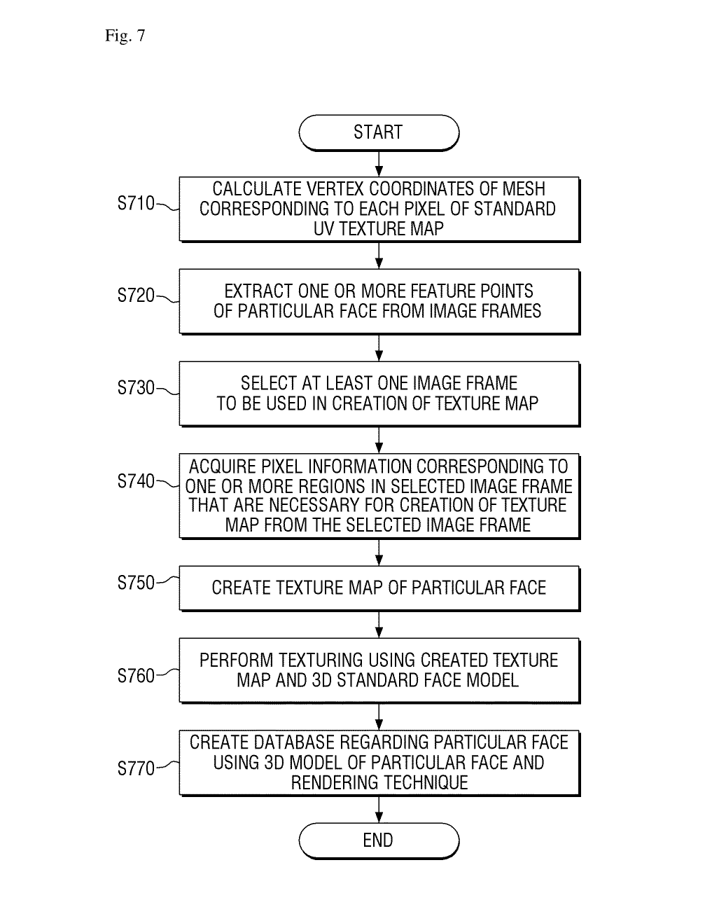

FIG. 7 is a flowchart illustrating a method of creating a database for face recognition, according to an exemplary embodiment of the invention, which uses the method of FIGS. 1 to 6.

The method of FIG. 7 may be performed by a computing device equipped with calculating means. The computing device may be, for example, a system using an apparatus for creating a texture map, according to an exemplary embodiment of the invention.

Referring to FIG. 7, operations S710, S720, S730, S740, and S750 are similar to their respective counterparts of the method of FIGS. 1 to 6, except that a particular object and a 3D standard object model that are used are a human face and a 3D standard face model.

That is, a texture map of a particular face included in an image frame captured by a camera is created (S750).

Texturing is performed using the texture map of the particular face, calculated vertex coordinates and a 3D standard face model (S760).

More specifically, a 3D model of the particular face may be created by texturing the texture map of the particular face onto the 3D standard face model.

A database is created regarding the particular face by collecting various data regarding the particular face using the 3D model of the particular face and a rendering technique (S770).

More specifically, the 3D model of the particular model may be rotated and/or zoomed in or out from various viewpoints, thereby creating the database. The database may be diversified by adding a lighting factor.

By using the database obtained by the method of FIG. 7, it is possible to improve the precision of the recognition of a face from an image captured by a camera.

FIG. 8 is a block diagram of an apparatus for creating a texture map, according to an exemplary embodiment of the invention.

The foregoing description of the method of FIGS. 1 to 6 is directly applicable to an apparatus 100 for creating a texture map, which will hereinafter be described with reference to FIG. 8.

Referring to FIG. 8, the apparatus 100 may include a coordinate calculation unit 110, a feature point extraction unit 120, a frame selection unit 130, a time information acquisition unit 140, a pixel information acquisition unit 150, and a texture map creation unit 160.

The coordinate calculation unit 110 may calculate vertex coordinates using a standard object model and a standard UV texture map.

The feature point extraction unit 120 may extract one or more feature points of a particular object from one or more image frames.

The frame selection unit 130 may select at least one of the image frames as an image frame to be used in the creation of a texture map of the particular object based on feature point information such as the number of feature points extracted.

The time information acquisition unit 140 may acquire capture time information of the selected image frame.

The pixel information acquisition unit 150 may acquire pixel information corresponding to one or more regions in the selected image frame that are necessary for the creation of a texture map from the selected image frame by using the capture time information of the selected image frame and the calculated vertex coordinates.

The texture map generation unit 160 creates the texture map of the particular object using the selected image frame and the pixel information. The creation of a texture map by the texture map creation unit 160 may be performed as illustrated in FIG. 6.

FIG. 9 is a configuration view of the apparatus of FIG. 8.

The apparatus 100 may have the configuration as illustrated in FIG. 9. The apparatus 100 may include a processor 1, which executes instructions, a memory 2, a storage 3 in which program data for creating a texture map is stored, a network interface 4, which is for transmitting data to or receiving data from an external device, and a data bus 5.

The data bus 5 may be connected to the processor 1, the memory 2, the storage 3, and the network interface 4 and may thus serve as a path for the transfer of data.

The storage 3 may store the program data for creating a texture map. The program data for creating a texture map may include a process of extracting feature points of a particular object from one or more image frames captured by a camera, a process of selecting at least one of the image frames as an image frame to be used in the creation of a texture map of the particular object based on information regarding the extracted feature points, and a process of creating the texture map of the particular object using the selected image frame.

The method of creating a texture map that has been described above with reference to FIGS. 1 to 7 may be performed by executing a computer program realized in the form of computer-readable code on a computer-readable medium. Examples of the computer-readable medium include a portable recording medium (such as a compact disc (CD), a digital versatile disc (DVD), a Blu-ray disc, a universal serial bus (USB) storage device, a portable hard disk, and the like) and a stationary recording medium (such as a read-only memory (ROM), a random access memory (RAM), an internal hard disk, and the like). The computer program may be transmitted from a first computing device to a second computing device via a network such as the Internet and may then be installed and used in the second computing device. Examples of the first and second computing devices include stationary computing devices such as a server device, a desktop personal computer (PC), and the like, mobile computing devices such as a notebook computer, a smartphone, a tablet PC, and the like, and wearable computing devices such as a smart watch, smart glasses, and the like.

The elements of the apparatus of FIG. 8 include software or hardware elements such as a field-programmable gate array (FPGA) or an application-specific integrated circuit (ASIC). However, the elements of the apparatus of FIG. 8 are not particularly limited to software or hardware elements. That is, the elements of the apparatus of FIG. 8 may be configured to reside in an addressable storage medium or to execute one or more processors. Functions provided within the elements of the apparatus of FIG. 8 may be combined into fewer elements or further separated into additional elements.

The exemplary embodiments of the invention have been described with reference to the accompanying drawings. However, those skilled in the art will appreciate that many variations and modifications can be made to the disclosed embodiments without substantially departing from the principles of the invention. Therefore, the disclosed embodiments of the invention are used in a generic and descriptive sense only and not for purposes of limitation.

What is claimed is:

1. A method of creating a texture map, comprising:
extracting feature points of an object from at least one image frame captured by a camera;
selecting the at least one image frame captured by the camera as an image frame to be used in the creation of a texture map of the object based on information regarding the extracted feature points; and
creating the texture map of the object using the selected at least one image frame.

2. The method of claim 1, wherein the selecting the comprises in response to a first image frame, among the at least one image frame captured by the camera, including an entire first group of feature points that is set in advance, selecting only the first image frame as the at least one image frame to be used in the creation of the texture map of the object, and
wherein the creating comprises creating a single texture map using the selected first image frame.

3. The method of claim 1, wherein the selecting comprises selecting two or more of the at least one image frame captured by the camera from which more than a predefined number of feature points are extracted, and
wherein the creating comprises:
creating two or more texture maps using the selected two or more image frames; and
creating a final texture map by matching the created two or more texture maps.

4. The method of claim 3, wherein the creating the final texture map comprises performing blending on boundaries that are formed in the process of matching the created two or more texture maps.

5. The method of claim 3, wherein the selecting comprises in response to the selected two or more image frames including an entire first group of feature points that is set in advance, selecting no further image frame.

6. The method of claim 1, wherein the selecting comprises in response to there being only one image frame from which more than a predefined number of feature points are extracted and the image frame including only some of a first group of feature points that is set in advance, selecting only the one image frame as the at least one image frame to be used in the creation of the texture map of the object, and
wherein the creating comprises creating a first texture map using the selected at least one image frame, creating a second texture map by mirroring the first texture map, and creating the final texture map by matching the first texture map and the second texture map.

7. The method of claim 6, wherein the creating the final texture map comprises performing blending on boundaries that are formed in the process of the matching the first texture map and the second texture map.

8. The method of claim 1, further comprising:
enhancing the resolution of the selected image frame,
wherein the creating comprises creating the texture map of the particular object using the resolution-enhance image frame.

9. The method of claim 1, further comprising:
calculating vertex coordinates of a mesh corresponding to each pixel of a standard UV texture map using a three-dimensional (3D) standard object model and the standard UV texture map;
acquiring capture time information of the selected at least one image frame using the extracted feature points, feature points of the 3D standard object model, and parameters of the camera; and
acquiring pixel information corresponding to one or more regions in the at least one selected image frame that are necessary for the creation of the texture map of the object from the selected at least one image frame using the capture time information and the vertex coordinates,
wherein the creating comprises creating the texture map of the object using the pixel information.

10. A method of creating a database for face recognition, comprising:
calculating vertex coordinates of a mesh corresponding to each pixel of a standard UV texture map using a three-dimensional (3D) standard face model and the standard UV texture map;
extracting feature points of a face from at least one image frame;
selecting one of the at least one image frame as an image frame to be used in the creation of a texture map of the face based on the number of extracted feature points;
creating the texture map of the face using the selected at least one image frame;
creating a 3D model of the face by performing texturing using the texture map of the face, the vertex coordinates, and the 3D model of the face; and
creating the database using the 3D model of the face and a rendering technique.

11. An apparatus for creating a texture map, comprising:
a feature point extraction unit configured to extract feature points of an object from at least one image frame captured by a camera;
a frame selection unit configured to select at least one image frame captured by the camera as an image frame to be used in the creation of a texture map of the object based on information regarding the extracted feature points; and
a texture map creation unit configured to create the texture map of the object using the selected at least one image frame.

12. The apparatus of claim 11, wherein in response to a first image frame, among the at least one image frame captured by the camera, including an entire first group of feature points that is set in advance, the frame selection unit is configured to select only the first image frame as the at least one image frame to be used in the creation of the texture map of the object, and
wherein the texture map creation unit is configured to create a single texture map using the selected first image frame.

13. The apparatus of claim 11, wherein the frame selection unit is configured to select two or more of the at least one image frame captured by the camera from which more than a predefined number of feature points are extracted, and
wherein the texture map creation unit is configured to create two or more texture maps using the selected two or more of the at least one image frame and create a final texture map by matching the created two or more texture maps.

14. The apparatus of claim 11, wherein in response to there being only one image frame from which more than a predefined number of feature points are extracted and the image frame including only some of a first group of feature points that is set in advance, the frame selection unit is configured to select only the one image frame as the at least one image frame to be used in the creation of the texture map of the object, and
wherein the texture map creation unit is configured to create a first texture map using the selected at least one image frame, creates a second texture map by mirroring the first texture map, and create the final texture map by matching the first texture map and the second texture map.

15. The apparatus of claim 11, further comprising:
a coordinate calculation unit configured to calculate vertex coordinates of a mesh corresponding to each pixel of a standard UV texture map using a 3D standard object model and the standard UV texture map;
a time information acquisition unit configured to acquire capture time information of the selected at least one image frame using the extracted feature points, feature points of the 3D standard object model, and parameters of the camera; and
a pixel information acquisition unit configured to acquire pixel information corresponding to one or more regions in the selected at least one image frame that are necessary for the creation of the texture map of the object from the selected image frame using the capture time information and the vertex coordinates,
wherein the texture map creation unit creates the texture map of the object using the pixel information.
